(19) United States
(12) Patent Application Publication
(10) Pub. No.: US 2024/0123983 A1
(43) Pub. Date: Apr. 18, 2024

(54) TRAVELING SUPPORT SYSTEM AND TRAVELING SUPPORT METHOD

(71) Applicant: Mitsubishi Electric Corporation, Tokyo (JP)

(72) Inventors: Takuji MORIMOTO, Tokyo (JP); Tomoki Uno, Tokyo (JP); Taku Umeda, Tokyo (JP); Yuta Takashima, Tokyo (JP)

(73) Assignee: Mitsubishi Electric Corporation, Tokyo (JP)

(21) Appl. No.: 18/346,593

(22) Filed: Jul. 3, 2023

(30) Foreign Application Priority Data
Oct. 17, 2022 (JP) 2022-166029

(51) Int. Cl. B60W 30/095; B60W 30/09; B60W 50/14

(52) U.S. Cl. CPC B60W 30/0956; B60W 30/09; B60W 50/14; B60W 2554/4041; B60W 2554/4046; B60W 2556/45

(57) ABSTRACT

To provide a traveling support system and a traveling support method which can switch a rough traveling support adapted to a rough merging behavior of the merging vehicle, and a traveling support of avoiding a collision between the object vehicle and the merging vehicle, according to conditions. A traveling support system comprising: a merging supporter that supports a traveling of the object vehicle so that a traveling at a time of merging becomes smooth; a collision avoidance supporter that calculates a collision risk and supports a traveling of the object vehicle so that the collision risk decreases; and a traveling support selector that determines whether the traveling support of the merging supporter or the traveling support of the collision avoidance supporter is performed.

### INCORPORATION BY REFERENCE

The disclosure of Japanese Patent Application No. 2022-166029 filed on Oct. 17, 2022 including its specification, claims and drawings, is incorporated herein by reference in its entirety.

### BACKGROUND

This present disclosure relates to a traveling support system and a traveling support method.

JP 6494121 B discloses the technology for predicting interruption of other vehicle, based on the positional relationship between the ego vehicle and the peripheral vehicle, and the lateral position. JP 6494121 B discloses the prediction method of interruption, based on road factors, such as the merging, as the modified example. JP 2021-014175 A discloses the technology for changing the operation of shortening the vehicle distance between the ego vehicle and the vehicle on the front side of the ego vehicle, and the operation of lengthening the vehicle distance, according to state of the merging vehicle.

### SUMMARY

By the way, in order to perform a traveling support such that the ego vehicle passes the merging section of lanes safely, a prediction according to the condition of the merging vehicle is required. For example, in a condition where the merging vehicle is distant from the end of merging lane, a rough prediction of the merging behavior of the merging vehicle by various factors, such as regulation and mutual concessions behavior, and a rough traveling support of the ego vehicle are required. On the other hand, in a condition where the merging vehicle approached the merging point, since the possibility of collision between the ego vehicle and the merging vehicle increases, a relatively strict traveling support of predicting movement of the merging vehicle and movement of the ego vehicle relatively strictly, and avoiding the collision is required.

However, in the technology of JP 6494121 B, based on the positional relationship in the longitudinal direction between the merging vehicle, the peripheral vehicle, and the virtual vehicle at the end of the merging lane, and the lateral position of the merging vehicle, the merging probability is predicted relatively strictly. However, as mentioned above, depending on the condition, the rough merging behavior by factors, such as regulation and mutual concessions, occurs. However, by the technology of predicting relatively strictly like JP 6494121 B, it is difficult to predict the rough merging behavior.

In the technology of JP 2021-014175 A, according to the state of the merging vehicle, the vehicle distance on the front side of the ego vehicle is shortened or lengthened. However, the rough merging behavior by factors, such as regulation and mutual concessions, is not predicted.

Then, the purpose of the present disclosure is to provide a traveling support system and a traveling support method which can switch a rough traveling support adapted to a rough merging behavior of the merging vehicle, and a traveling support of avoiding a collision between the object vehicle and the merging vehicle, according to conditions.

A traveling support system according to the present disclosure including:
an information acquisition unit that acquires movement information of an object vehicle, movement information of a merging vehicle which is traveling on a merging lane which merges into an object lane where the object vehicle is traveling, lane information of the object lane, and lane information of the merging lane;
a merging behavior prediction unit that predicts a merging behavior into the object lane of the merging vehicle, based on the movement information of the object vehicle, the movement information of the merging vehicle, the lane information of the object lane, and the lane information of the merging lane;
a merging support unit that supports at least a traveling of the object vehicle so that a traveling at a time of merging becomes smooth, based on a prediction result of the merging behavior;
a movement prediction unit that predicts a movement of the object vehicle and a movement of the merging vehicle, based on the movement information of the object vehicle, the movement information of the merging vehicle, the lane information of the object lane, and the lane information of the merging lane;
a collision avoidance support unit that calculates a collision risk between the object vehicle and the merging vehicle, based on a prediction result of the movement of the object vehicle, and a prediction result of the movement of the merging vehicle, and supports at least a traveling of the object vehicle so that the collision risk decreases; and
a traveling support selection unit that determines whether a traveling support of the merging support unit or a traveling support of the collision avoidance support unit is performed, and makes determined the merging support unit or the collision avoidance support unit perform the traveling support.

A traveling support method according to present disclosure including:
an information acquisition step of acquiring movement information of an object vehicle, movement information of a merging vehicle which is traveling on a merging lane which merges into an object lane where the object vehicle is traveling, lane information of the object lane, and lane information of the merging lane;
a merging behavior prediction step of predicting a merging behavior into the object lane of the merging vehicle, based on the movement information of the object vehicle, the movement information of the merging vehicle, the lane information of the object lane, and the lane information of the merging lane;
a merging support step of supporting at least a traveling of the object vehicle so that a traveling at the time of merging becomes smooth, based on a prediction result of the merging behavior;
a movement prediction step of predicting a movement of the object vehicle and a movement of the merging vehicle, based on the movement information of the object vehicle, the movement information of the merging vehicle, the lane information of the object lane, and the lane information of the merging lane;
a collision avoidance support step of calculating a collision risk between the object vehicle and the merging vehicle, based on a prediction result of the movement of the object vehicle, and a prediction result of the movement of the merging vehicle, and supports at least a traveling of the object vehicle so that the collision risk decreases; and
a traveling support selection step of determining whether a traveling support of the merging support step or a traveling support of the collision avoidance support step is performed, and makes determined the merging support step or the collision avoidance support step perform the traveling support.

According to the traveling support system and the traveling support method of the present disclosure, the merging behavior into the object lane of the merging vehicle is predicted by the merging behavior prediction unit; and at least the traveling of the object vehicle is supported so that the traveling at the time of merging becomes smooth, based on the prediction result of the merging behavior, by the merging support unit. Accordingly, by the merging behavior prediction unit and the merging support unit, based on the rough prediction result of the merging behavior, the rough traveling support such that the traveling at the time of merging becomes smooth is performed. On the other hand, the movement of the object vehicle and the movement of the merging vehicle are predicted by the movement prediction unit. And, by the collision avoidance support unit, the collision risk between the object vehicle and the merging vehicle is calculated based on the prediction result of movement of the object vehicle and the merging vehicle, and at least the traveling of the object vehicle is supported so that the collision risk decreases. Accordingly, by calculating the collision risk based on the movement of each vehicle by the movement prediction unit and the collision avoidance support unit, the traveling support such as avoiding collision more certainly is performed. By determining whether the traveling support of the merging support unit or the traveling support of the collision avoidance support unit is performed by the traveling support selection unit, the rough traveling support such that the traveling at the time of merging becomes smooth, and the traveling support such as avoiding collision certainly can be switched appropriately according to conditions.

### BRIEF DESCRIPTION OF THE DRAWINGS

FIG. 1 is a schematic block diagram of the vehicle control apparatus and the traveling support system according to Embodiment 1;

FIG. 2 is a schematic hardware configuration diagram of the vehicle control apparatus according to Embodiment 1;

FIG. 3 is a schematic hardware configuration diagram of the vehicle control apparatus according to Embodiment 1;

FIG. 4 is a figure for explaining the ego vehicle coordinate system according to Embodiment 1;

FIG. 5 is a schematic diagram for explaining the merging in the highway and the like according to Embodiment 1;

FIG. 6 is a schematic diagram for explaining the merging due to the traveling regulation according to Embodiment 1;

FIG. 7 is a schematic diagram for explaining the merging in the intersection according to Embodiment 1;

FIG. 8 is a schematic diagram for explaining the front and back relation when the angle between the ego lane and the merging lane is small according to Embodiment 1;

FIG. 9 is a schematic diagram for explaining the front and back relation when the angle between the ego lane and the merging lane is large according to Embodiment 1;

FIG. 10 is a schematic diagram for explaining the prediction model using the boundary line according to Embodiment 1;

FIG. 11 is a schematic diagram for explaining the calculation of the collision risk according to Embodiment 1;

FIG. 12 is a schematic diagram for explaining the plurality of movement patterns of the merging vehicle according to Embodiment 1;

FIG. 13 is a schematic diagram for explaining the switching of the traveling supports according to the distance from the merging vehicle to the merging point according to Embodiment 1;

FIG. 14 is a flowchart for explaining the processing of the traveling support system according to Embodiment 1;

FIG. 15 is a flowchart for explaining the processing of the traveling support system according to Embodiment 2; and

FIG. 16 is a schematic block diagram of the vehicle control apparatus and the traveling support system according to Embodiment 3.

### DETAILED DESCRIPTION OF THE EMBODIMENTS

### 1. Embodiment 1

A traveling support system 1 according to Embodiment 1 will be explained with reference to drawings. In the present embodiment, the traveling support system 1 is provided in an object vehicle (ego vehicle). The traveling support system 1 is embedded into the vehicle control apparatus 50.

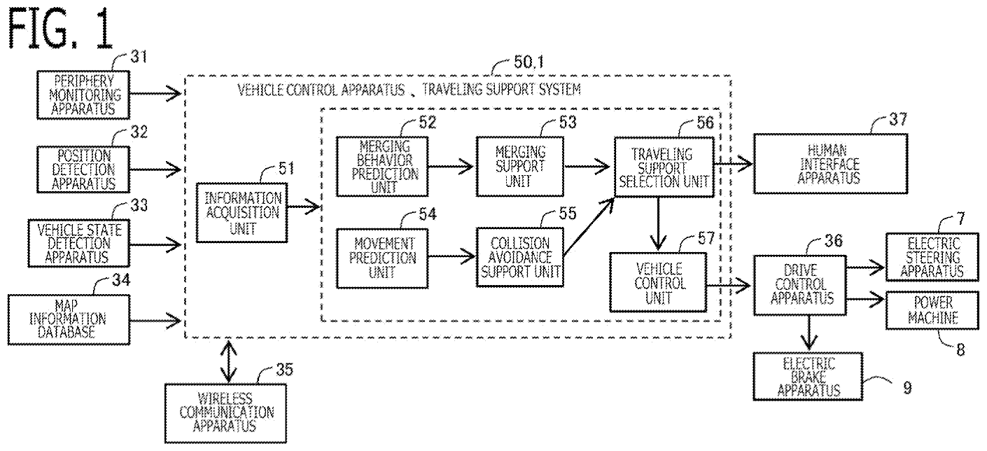

As shown in FIG. 1, an object vehicle (ego vehicle) is provided with a periphery monitoring apparatus 31, a position detection apparatus 32, a vehicle state detection apparatus 33, a map information database 34, a wireless communication apparatus 35, a vehicle control apparatus 50, a drive control apparatus 36, a power machine 8, an electric steering apparatus 7, an electric brake apparatus 9, a human interface apparatus 37, and the like.

The periphery monitoring apparatus 31 is an apparatus which monitor the periphery of vehicle, such as a camera and a radar. As the radar, a millimeter wave radar, a laser radar, an ultrasonic radar, and the like are used. The wireless communication device 35 performs a wireless communication with a base station, using the wireless communication standard of cellular communication system, such as 4G and 5G.

The position detecting apparatus 32 is an apparatus which detects the current position (latitude, longitude, altitude) of the ego vehicle, and a GPS antenna which receives the signal outputted from satellites, such as GNSS (Global Navigation Satellite System), is used. For detection of the current position of the ego vehicle, various kinds of methods, such as the method using the traveling lane identification number of the ego vehicle, the map matching method, the dead reckoning method, and the method using the detection information around the ego vehicle, may be used.

In the map information database 34, road information, such as a road shape (for example, a lane number, a position of each lane, a shape of each lane, a type of each lane, a road type, a regulation speed, and the like), a sign, and a road signal, is stored. The map information database 34 is mainly constituted of a storage apparatus. The map information database 34 may be provided in a server outside the vehicle connected to the network, and the vehicle control apparatus 50 may acquire required road information from the server outside the vehicle via the wireless communication apparatus 35.

As the drive control apparatus 36, a power controller, a brake controller, an automatic steering controller, a light controller, and the like are provided. The power controller controls output of a power machine 8, such as an internal combustion engine and a motor. The brake controller controls brake operation of the electric brake apparatus 9. The automatic steering controller controls the electric steering apparatus 7. The light controller controls a direction indicator, a hazard lamp, and the like.

The vehicle condition detection apparatus 33 is a detection apparatus which detects an ego vehicle state which is a driving state and a traveling state of the ego vehicle. In the present embodiment, the vehicle state detection apparatus 33 detects a speed, an acceleration, a yaw rate, a steering angle, a lateral acceleration and the like of the ego vehicle, as the traveling state of the ego vehicle. For example, as the vehicle state detection apparatus 33, a speed sensor which detects a rotational speed of wheels, an acceleration sensor, an angular speed sensor, a steering angle sensor, and the like are provided.

As the driving state of the ego vehicle, an acceleration or deceleration operation, a steering angle operation, and a lane change operation by a driver are detected. For example, as the vehicle state detection apparatus 33, an accelerator position sensor, a brake position sensor, a steering angle sensor (handle angle sensor), a steering torque sensor, a direction indicator position switch, and the like are provided.

The human interface apparatus 37 is an apparatus which receives input of the driver or transmits information to the driver, such as a loudspeaker, a display screen, an input device, and the like.

### 1-1. Vehicle Control Apparatus 50

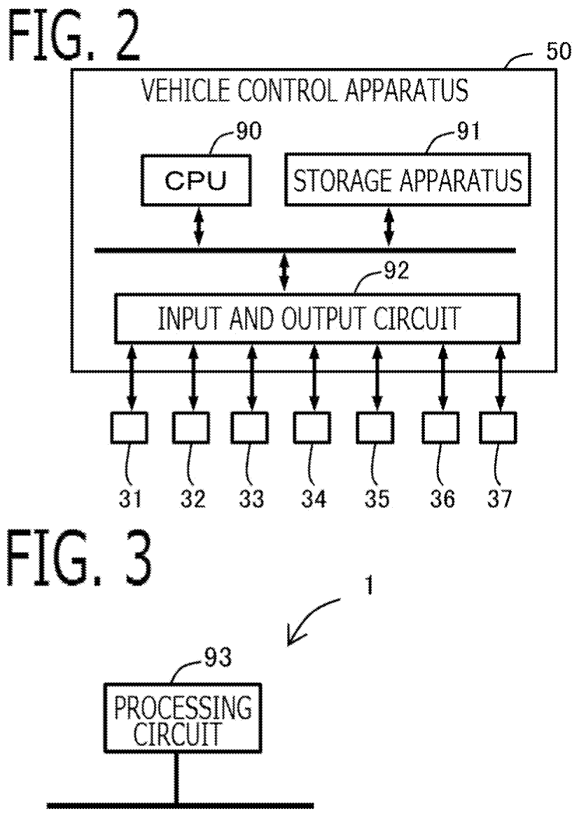

The vehicle control apparatus 50 is provided with functional units of an information acquisition unit 51, a merging behavior prediction unit 52, a merging support unit 53, a movement prediction unit 54, a collision avoidance support unit 55, a traveling support selection unit 56, a vehicle control unit 57, and the like. Each function of the vehicle control apparatus 50 is realized by processing circuits provided in the vehicle control apparatus 50. As shown in FIG. 2, specifically, the vehicle control apparatus 50 is provided with an arithmetic processor 90 such as CPU (Central Processing Unit), storage apparatuses 91, an input and output circuit 92 which outputs and inputs external signals to the arithmetic 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatus, such as RAM (Random Access Memory), ROM (Read Only Memory), a flash memory, EEPROM (Electrically Erasable Programmable Read Only Memory), and a hard disk, are used.

The input and output circuit 92 is provided with a communication device, an A/D converter, an input/output port, a driving circuit, and the like. The input and output circuit 92 is connected to the periphery monitoring apparatus 31, the position detection apparatus 32, the vehicle state detection apparatus 33, the map information database 34, the wireless communication apparatus 35, the drive control apparatus 36, and the human interface apparatus 37, and communicates with these devices.

Then, the arithmetic processor 90 runs software items (programs) stored in the storage apparatus 91 and collaborates with other hardware devices in the vehicle control apparatus 50, such as the storage apparatus 91, and the input and output circuit 92, so that the respective functions of the functional units 51 to 57 provided in the vehicle control apparatus 50 are realized. Setting data, such as the parameters of prediction model and the threshold value, utilized in the functional units 51 to 57 are stored in the storage apparatus 91, such as EEPROM.

Alternatively, as shown in FIG. 3, the vehicle control apparatus 50 may be provided with a dedicated hardware 93 as the processing circuit, for example, a single circuit, a combined circuit, a programmed processor, a parallel programmed processor, ASIC, FPGA, GPU, AI chip, or a circuit which combined these. Each function of the vehicle control apparatus 50 will be described in detail below.

### 1-1-1. Information Acquisition Unit 51

The information acquisition unit 51 acquires movement information of the ego vehicle. In the present embodiment, the information acquisition unit 51 acquires a position, a moving direction, a speed, an acceleration, and the like of the ego vehicle, based on position information of the ego vehicle acquired from the position detection apparatus 32, and an ego vehicle state acquired from the vehicle state detection apparatus 33.

The information acquisition unit 51 acquires movement information of a peripheral vehicle which exists around the ego vehicle. A merging vehicle described below is also included in the peripheral vehicle. In the present embodiment, the information acquisition unit 51 acquires a position, a moving direction, a speed, an acceleration, and the like of the peripheral vehicle, based on detection information acquired from the periphery monitoring apparatus 31, and position information of the ego vehicle acquired from the position detection apparatus 32. The information acquisition unit 51 also acquires information of an obstacle, a pedestrian, a sign, a traffic regulation such as lane regulation, and the like, other than the peripheral vehicle.

The information acquisition unit 51 can acquire the movement information of the peripheral vehicle, and the lane information of the peripheral vehicle from the outside of the ego vehicle by communication. The merging vehicle is also included in the peripheral vehicle. For example, the information acquisition unit 51 may acquire the movement information of the peripheral vehicle (the position, the moving direction, the speed, and the like of the peripheral vehicle) and the like from the peripheral vehicle by the wireless communication and the like. The information acquisition unit 51 may acquire the movement information of the peripheral vehicle which exists in the monitor area (the position, the moving direction, the speed, the acceleration, and the like of the peripheral vehicle), the information of the obstacle and the pedestrian, the road shape, the traffic regulation, the traffic state, and the like, from a roadside machine, such as a camera which monitors road state, by the wireless communication and the like.

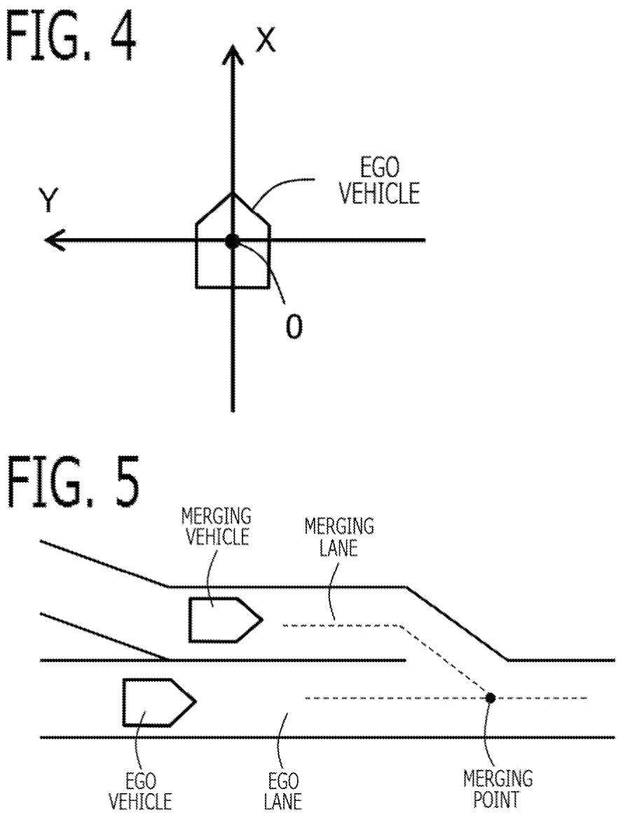

In the present embodiment, the information acquisition unit 51 acquires a relative position and a relative speed of the peripheral vehicle and the like with respect to the ego vehicle in an ego vehicle coordinate system on the basis of the current position of the ego vehicle. As shown in FIG. 4, the ego vehicle coordinate system is a coordinate system which has two axes of a longitudinal direction X and a lateral direction Y of the current ego vehicle. The information acquisition unit 51 may acquire the relative position and the relative speed of the peripheral vehicle in a coordinate system of a longitudinal direction and a lateral direction of the ego lane (object lane) where the ego vehicle is traveling. The information acquisition unit 51 may acquire an absolute position (latitude, longitude), an absolute moving direction (azimuth), an absolute speed, an absolute acceleration, and the like of each vehicle.

The information acquisition unit 51 acquires road information around the ego vehicle from the map information database 34, based on the position information of the ego vehicle acquired from the position detection apparatus 32. The acquired road information includes the lane number, the position of each lane, the shape of each lane, the type of each lane, the road type, the regulation speed, and the like. The merging lane, the main lane, and the like are included in the type of each lane. The information acquisition unit 51 acquires information of traffic regulation, such as a lane regulation due to construction, from the external server and the like.

And, the information acquisition unit 51 detects a shape and a type of the lane marking and the like of road, based on detection information of the lane marking, such as a white line and a road shoulder, acquired from the periphery monitoring apparatus 31; and determines a shape and a position of each lane, a lane number, a type of each lane, and the like, based on the detected shape and the type of the lane marking and the like of road. The merging lane and the like are included in the type of each lane. The information acquisition unit 51 also determines presence or absence of the traffic regulation, such as the lane regulation.

The information acquisition unit 51 acquires the lane information corresponding to a lane where the ego vehicle is traveling, based on the position of the ego vehicle. The information acquisition unit 51 acquires the lane information corresponding to a lane where each peripheral vehicle is traveling, based on the position of each peripheral vehicle. The shape, the position, and the type of lane and the lane information of the peripheral lane is included in the acquired lane information.

### <Definition of Merging and the Like>

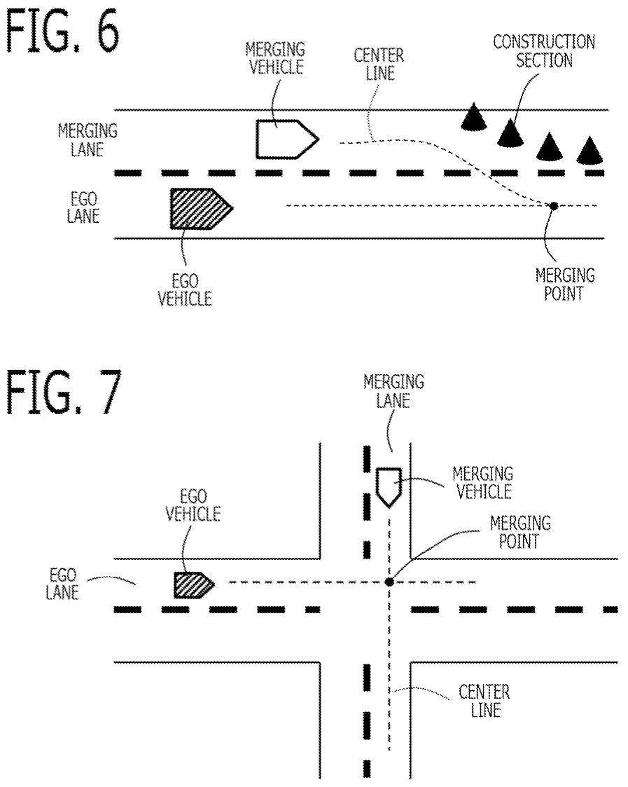

The merging means a road shape where lanes cross. And, a merging in a highway (refer to FIG. 5), a merging from an added lane, a merging due to a decrease in lane number, a merging due to a temporary traveling regulation, such as construction (refer to FIG. 6), an intersection (refer to FIG. 7), and the like are included. A lane where the ego vehicle (object vehicle) is traveling is defined as an ego lane (object lane), and a lane which merges into the ego lane is defined as a merging lane. A merging point is a merging point between the merging lane and the ego lane. For example, the merging point may be set to a point where the center line of the ego lane and the center line of the merging lane cross, or may be set to a specific point which is set in front or back of the intersection point of the center lines. The merging point may be set to a start point of a taper part where the lane width of the merging lane becomes narrow gradually, for example. In the case of the temporary traveling regulation, a virtual center line may be set in a lane area where traveling is possible in the lane (merging lane) with the traveling regulation, and a point where the center line of the ego lane and the virtual center line of the merging lane cross may be set as the merging point. A start point of the traveling regulation may be set as the merging point.

The information acquisition unit 51 determines the merging lane which merges into the ego lane (object lane) where the ego vehicle is traveling, determines the merging vehicle which is traveling on the merging lane from the peripheral vehicles, and acquires the movement information of the merging vehicle and the lane information of the merging lane, as mentioned above.

### 1-1-2. Vehicle Control Unit 57

When performing an automatic driving, the vehicle control unit 57 determines a target traveling trajectory adjusted with the state of the peripheral vehicle, the obstacle, and the pedestrian, and the road shape around of ego vehicle which were detected by the information acquisition unit 51. The target traveling trajectory is a time series traveling plan of the position of the ego vehicle, the traveling direction of the ego vehicle, the speed of the ego vehicle, the traveling lane, the lane change position, and the like at each future time. The vehicle control unit 57 generates the target traveling trajectory for performing deceleration or acceleration, a lane change, and the like according to a command of the traveling support by the merging support unit 53 or the collision avoidance support unit 55.

The vehicle control unit 57 controls the vehicle so as to follow the target traveling trajectory of the ego vehicle. For example, the vehicle control unit 57 decides a target speed, a target steering angle, an operation command of the direction indicator, and the like. Each decided command value is transmitted to the drive control apparatus 36, such as the power controller, the brake controller, the automatic steering controller, and the light controller.

The power controller controls the output of the power machine 8, such as the internal combustion engine and the motor, so that the speed of the ego vehicle follows the target speed. The brake controller controls the brake operation of the electric brake apparatus 9 so that the speed of the ego vehicle follows the target speed. The automatic steering controller controls the electric steering apparatus 7 so that the steering angle follows the target steering angle. The light controller controls the direction indicator according to the operation command of the direction indicator.

Alternatively, when manual driving or semiautomatic driving by driver is performed, the vehicle control unit 57 transmits commands to the power controller and the brake controller so as to perform deceleration or acceleration, according to the command of the traveling support by the merging support unit 53 or the collision avoidance support unit 55; and controls the output of the power machine 8 and controls the brake operation of the electric brake apparatus 9. At this time, the steering angle may also be controlled by the electric steering apparatus 7.

### 1-1-3. Merging Behavior Prediction Unit 52

The merging behavior prediction unit 52 predicts a merging behavior into the ego lane of the merging vehicle, based on the movement information of the ego vehicle, the movement information of the merging vehicle, the lane information of the ego lane (object lane), and the lane information of the merging lane.

The merging behavior prediction unit 52 predicts the merging behavior of the merging vehicle, without calculating the collision risk which is based on the prediction result of movement of each vehicle, unlike the movement prediction unit 54. For example, classification of the merging behavior is predicted.

For example, the merging behavior prediction unit 52 predicts the merging behavior of the merging vehicle on the front side or the back side with respect to the ego vehicle, such that the merging vehicle merges on the front side of the ego vehicle, or merges on the back side of the ego vehicle. The prediction result includes at least a qualitative front or back merging position, such as the merging on the front side of the ego vehicle, or the merging on the back side of the ego vehicle. The prediction result may also include a front or back distance of the merging vehicle with respect to the ego vehicle at the time of merging, or a merging prediction time such as merging in certain seconds from now on.

The merging behavior prediction unit 52 may predict the qualitative front or back merging position including a front side or back side vehicle of the ego vehicle, such as merging between the ego vehicle and the front side vehicle of the ego vehicle, or merging between the ego vehicle and the back side vehicle of the ego vehicle.

### <Example of Prediction of Merging Behavior>

As a simple method, the merging behavior prediction unit 52 predicts that the merging vehicle merges on the front side of the ego vehicle, when the merging vehicle is traveling in the front of the ego vehicle; and predicts that the merging vehicle merges on the back side of the ego vehicle, when the merging vehicle is traveling in the back of the ego vehicle.

Alternatively, the merging behavior prediction unit 52 may predict whether the merging vehicle merges on the front side or the back side of the ego vehicle, by assuming that the merging vehicle and the ego vehicle travel while maintaining the current speed. The accelerations of the merging vehicle and the ego vehicle, a planned speed of the ego vehicle, and an estimated planned speed of the merging vehicle may be considered.

By assuming that the ego vehicle travels while maintaining the current speed, the merging behavior prediction unit 52 may calculate a speed change of the merging vehicle which is caused when the merging vehicle merges on the front side of the ego vehicle, and a speed change of the merging vehicle which is caused when the merging vehicle merges on the back side of the ego vehicle. The merging behavior prediction unit 52 may predict that the merging vehicle selects either smaller one of an absolute value of the speed change of the front side merging or an absolute value of the speed change of the back side merging.

### <Definition of Front and Back Relation>

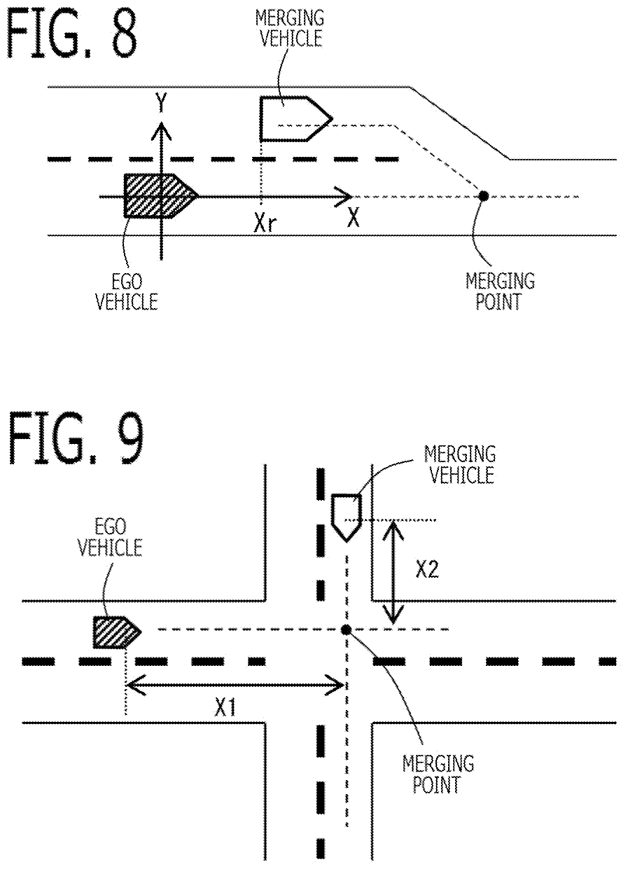

As shown in FIG. 8, when an angle between the ego lane and the merging lane is small, a front and back relation between the merging vehicle and the ego vehicle is determined in the longitudinal direction X of the ego vehicle or the ego lane. When the ego lane curves, the curve of the ego lane may be considered. On the other hand, as shown in FIG. 9, when the angle between the ego lane and the merging lane is large at the intersection and the like, the front and back relation between the merging vehicle and the ego vehicle is determined by a magnitude relation between distances with respect to the merging point. In either case, the front and back relation between the merging vehicle and the ego vehicle is correlated with the magnitude relation between the distance of the merging vehicle and the distance of the ego vehicle with respect to the merging point.

### <Prediction of Merging Behavior Using Prediction Model>

For example, the merging behavior prediction unit 52 predicts the merging behavior, using a prediction model which receives a feature value of at least one or both of a position and a speed of the merging vehicle, and outputs a prediction result of a merging position of the merging vehicle on front side or back side with respect to the ego vehicle.

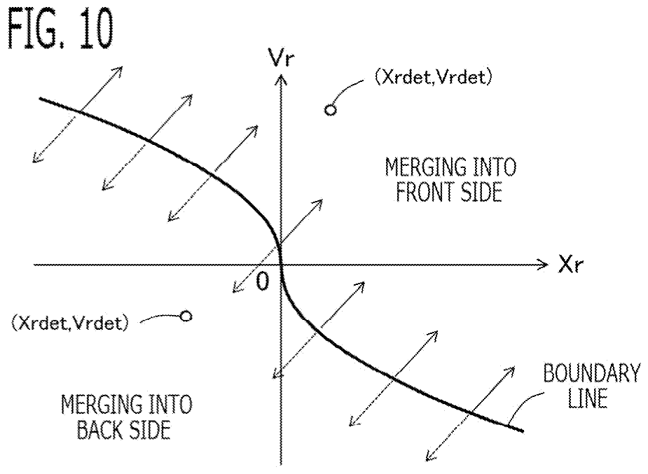

For example, for the prediction model, as shown in FIG. 10, a boundary line is set in a two-dimensional coordinate system which has axes of the relative position Xr and the relative speed Vr. The merging behavior prediction unit 52 predicts whether the merging vehicle merges on the front side or the back side of the ego vehicle, based on a relative position relation of the detection value of the relative position Xrdet and the detection value of the relative speed Vrdet of the merging vehicle, with respect to the boundary line. When the angle between the ego lane and the merging lane is small, the relative position and the relative speed are set in the longitudinal direction of the ego vehicle or the ego lane. When the angle between the ego lane and the merging lane is large, a difference between the distances of respective vehicles with respect to the merging point is set as the relative position, and a difference between the speeds in the longitudinal direction of respective vehicles is set as the relative speed.

The boundary line that the relative position Xr decrease from 0 is set as the relative speed Vr increases from 0, and the boundary line that the relative position Xr increase from 0 is set as the relative speed Vr decreases from 0. The boundary line may be designed and tuned using a statistical method. A model of the boundary line learned by machine learning using the past data may be used. An inclination and a shape of the boundary line may be changed based on the feature of the merging lane and the ego lane (for example, a speed difference between the merging lane and the ego lane, a length of the merging lane). The inclination and the shape of the boundary line may be changed based on a distance from the merging vehicle to the end of the merging lane.

When the detection value of the relative position Xrdet and the detection value of the relative speed Vrdet of the merging vehicle are located on the increase side of the relative position Xr and the relative speed Vr with respect to the boundary line, the merging behavior prediction unit 52 predicts that the merging vehicle merges on the front side of the ego vehicle. When the detection value of the relative position Xrdet and the detection value of the relative speed Vrdet of the merging vehicle are located on the decrease side of the relative position Xr and the relative speed Vr with respect to the boundary line, the merging behavior prediction unit 52 predicts that the merging vehicle merges on the back side of the ego vehicle.

The merging behavior prediction unit 52 may predict the front or back distance of the merging vehicle with respect to the ego vehicle at the time of merging, based on the distance of the detection value of the relative position Xrdet and the detection value of the relative speed Vrdet of the merging vehicle with respect to the boundary line. The merging position may be predicted considering the relative position of the peripheral vehicle, such as the front or back vehicle of the ego vehicle, and the like.

Alternatively, as the prediction model, a machine learning model, such as a neural network, may be used. The machine learning model learned previously a relation between input data and output data acquired in the past, by machine learning. In the past input data for learning, feature values of at least one or both of the position and the speed of the merging vehicle are included. For example, the relative position and the relative speed of the merging vehicle with respect to the ego vehicle, the distance from the merging vehicle to the end of the merging lane, the relative position of the front or back vehicle of the ego vehicle, and the like are included. In the past output data for learning, at least the merging result of the merging vehicle on the front side or the back side of the ego vehicle is included. Other than that, the front or back distance of the merging vehicle with respect to the ego vehicle at the time of merging, and the like may be included.

Herein, the machine learning means a general term of a method of constructing a prediction model based on the past data. The method of adjusting the parameter and the like of the boundary line based on the past data is also included in the machine learning.

Since it is difficult to formulize a behavior on the basis of various motives of the merging vehicle, a prediction model which is hardly designed by human is created based on the past data by using the machine learning. On the other hand, since the machine learning does not calculate the collision risk by formulizing the physical phenomenon, there is an anxiety for using it alone. Even if information useful for calculation of the collision risk, such as a time to collision between the ego vehicle and the merging vehicle, is inputted into the prediction model, since the prediction model just learns directly the relation between the input and the output, the physical collision risk between the ego vehicle and the merging vehicle is not explicitly calculated inside, and the collision risk may be calculated low even in the state where the collision occurs clearly. Then, in the present embodiment, the traveling support is not performed only using the prediction model by the machine learning, safety can be secured by providing the collision avoidance support unit 55 which calculates the collision risk and performs traveling support.

The well-known other various methods may be used, and the merging behavior into the ego lane of the merging vehicle may be predicted.

### 1-1-4. Merging Support Unit 53

The merging support unit 53 supports at least a traveling of the ego vehicle so that a traveling at the time of merging becomes smooth, based on the prediction result of the merging behavior of the merging vehicle. The traveling support of the merging support unit 53 is performed when the traveling support selection unit 56 determines that the traveling support of the merging support unit 53 is performed.

For example, the merging support unit 53 supports at least the traveling of the ego vehicle so that a vehicle distance between the ego vehicle and the merging vehicle at the time of merging is secured, based on the prediction result of the merging behavior of the merging vehicle. Specifically, when it is predicted that the merging vehicle merges on the front side of the ego vehicle, the merging support unit 53 makes the ego vehicle decelerate so that the vehicle distance can be secured. When it is predicted that the merging vehicle merges on the back side of the ego vehicle, the merging support unit 53 makes the ego vehicle accelerate so that the vehicle distance can be secured.

The merging support unit 53 sets a value obtained by increasing or decreasing from the current speed or the target speed of the ego vehicle, as the target speed; and changes one or both of the output of the power machine 8 and the braking force of the brake so that the speed of the ego vehicle follows the target speed. The merging support unit 53 may make the ego vehicle change lane to the adjacent lane, based on the prediction result of the merging behavior of the merging vehicle. In this way, the merging support unit 53 calculates a control value of the vehicle driving of the ego vehicle, as the traveling support of the ego vehicle.

The well-known other various methods may be used, and at least the traveling of the ego vehicle may be supported so that the traveling at the time of merging becomes smooth, based on the prediction result of the merging behavior of the merging vehicle.

The merging support unit 53 may generate notice information for urging a driving corresponding to the traveling support of the ego vehicle to the driver of the ego vehicle, as the traveling support of the ego vehicle; and may inform the notice information to the driver. The notice information includes information for urging a deceleration, an acceleration, or a lane change for making the traveling at the time of merging smooth. The notice information is outputted from the human interface apparatus 37, such as the loudspeaker or the display screen.

Not only the traveling of the ego vehicle, but also the traveling of the merging vehicle may be supported, or the traveling of the peripheral vehicle may also be supported.

### 1-1-5. Movement Prediction Unit 54 and Collision Avoidance Support Unit 55

The movement prediction unit 54 predicts a movement of the ego vehicle, and a movement of the merging vehicle, based on the movement information of the ego vehicle, the movement information of the merging vehicle, the lane information of the ego lane (object lane), and the lane information of the merging lane.

As a simple method, the movement prediction unit 54 predicts time series positions of the ego vehicle in the case where the ego vehicle travels along the ego lane while maintaining the current speed. The movement prediction unit 54 predicts the time series positions of the merging vehicle in the case where the merging vehicle travels along the merging lane while maintaining the current speed. When performing these prediction, the acceleration of each vehicle may be considered.

Alternatively, when the ego vehicle is performing the automatic driving and the target traveling trajectory in time series is set, the movement prediction unit 54 may predict the target traveling trajectory of the ego vehicle, as the movement of the ego vehicle in time series. The speed and the acceleration in the lateral direction of the merging vehicle may be considered.

The collision avoidance support unit 55 calculates a collision risk between the ego vehicle and the merging vehicle, based on the prediction result of movement of the ego vehicle, and the prediction result of movement of the merging vehicle; and supports at least the traveling of the ego vehicle so that the collision risk decreases. The traveling support of the collision avoidance support unit 55 is performed, when the traveling support selection unit 56 determines that the traveling support of the collision avoidance support unit 55 is performed.

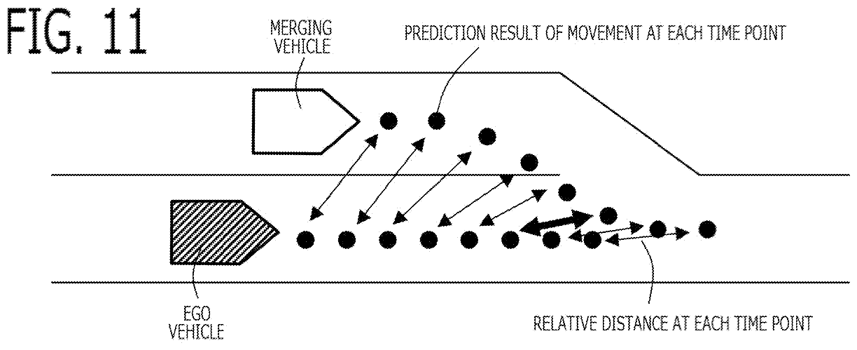

For example, as shown in FIG. 11, the collision avoidance support unit 55 calculates a relative distance between the position of the ego vehicle and the position of the merging vehicle at each time point; and calculates the collision risk at each time point, based on the relative distance at each time point. As the relative distance becomes short, the collision risk becomes large. The collision avoidance support unit 55 supports at least the traveling of the ego vehicle so that the collision risk at each time point decreases.

At time point when the collision risk becomes greater than or equal to a threshold value, the collision avoidance support unit 55 makes the ego vehicle decelerate until the collision risk becomes less than the threshold value, when the merging vehicle is located in the front of the ego vehicle; and makes the ego vehicle accelerate until the collision risk becomes less than the threshold value, or makes the ego vehicle maintain the speed, when the merging vehicle is located in the back of the ego vehicle. Alternatively, the collision avoidance support unit 55 may make the ego vehicle change lane to the adjacent lane. That is to say, the collision avoidance support unit 55 calculates the control value of the vehicle driving of the ego vehicle, as the traveling support of the ego vehicle.

The movement prediction unit 54 may predict a moving position range where the ego vehicle may be located, and a moving position range where the merging vehicle may be located, at each time point. In the prediction of ranges, uncertainty and error are considered.

The collision avoidance support unit 55 calculates an overlap degree or a separation degree between the moving position range of the ego vehicle and the moving position range of the merging vehicle, at each time point; and calculates the collision risk at each time point, based on the overlap degree or the separation degree at each time point. As the overlap degree becomes large, or the separation degree becomes small, the collision risk becomes large. Then, similarly to above, the collision avoidance support unit 55 supports at least the traveling of the ego vehicle so that the collision risk at each time point decreases. For example, the overlap degree is calculated according to an overlap distance where the moving position range of the ego vehicle and the moving position range of the merging vehicle are overlapped, when the moving position range of the ego vehicle and the moving position range of the merging vehicle are overlapped. The separation degree is calculated according to a separation distance where the moving position range of the ego vehicle and the moving position range of the merging vehicle are separated, when the moving position range of the ego vehicle and the moving position range of the merging vehicle is separated.

Alternatively, as a simple method, the collision avoidance support unit 55 may calculate a time to collision (TTC) as the collision risk, based on the relative distance and the relative speed between the ego vehicle and the merging vehicle. For example, the time to collision is calculated by dividing the relative distance by the relative speed. The collision avoidance support unit 55 supports at least the traveling of the ego vehicle so that the time to collision increases.

<Selection from a Plurality of Movement Patterns>

The movement prediction unit 54 selects a movement pattern with high selection probability from a plurality of movement patterns which the merging vehicle may perform; and predicts the movement of the merging vehicle on condition of the selected movement pattern.

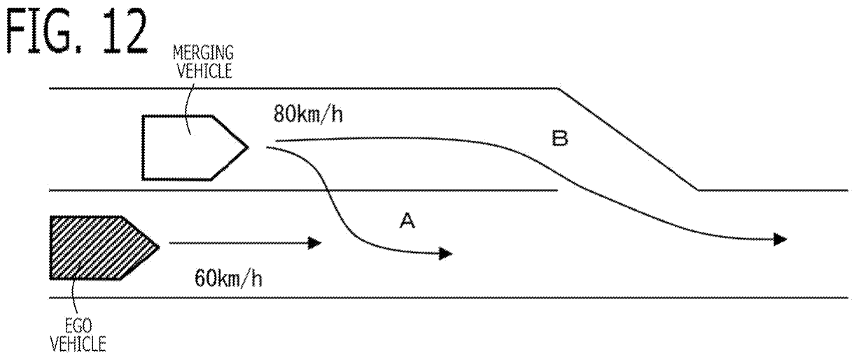

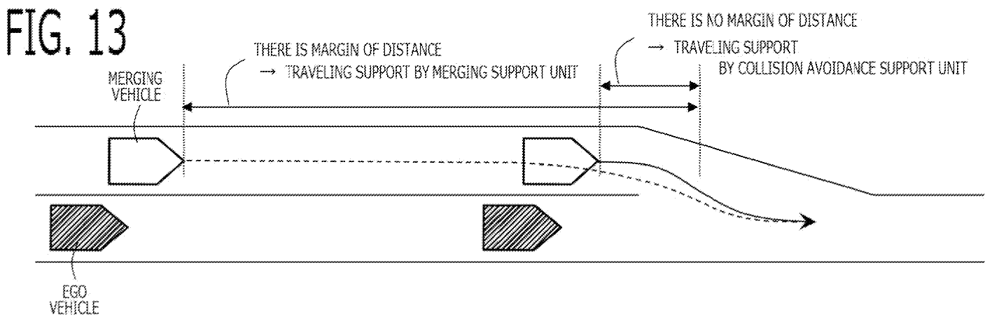

For example, in the example shown in FIG. 12, a movement pattern A which merges in the middle of the merging lane, and a movement pattern B which merges in the vicinity of the end of the merging lane can be considered. In these conditions, when the merging vehicle is already faster than the ego vehicle, compared with A, B may secure the vehicle distance between the merging vehicle and the ego vehicle, and may be able to merge safely. In this case, by assuming that the merging vehicle selects B, and predicting the movement of the merging vehicle in B, high precision support is achieved. On the other hand, when the merging vehicle merges with a margin with respect to the end of the merging lane, it may be assumed that the merging vehicle selects A.

The well-known other various methods may be used, and the movement of the ego vehicle and the movement of the merging vehicle may be predicted. The well-known other various methods may be used, and the collision risk may be calculated. The well-known other various methods may be used, and at least the traveling of the ego vehicle may be supported so that the collision risk decreases.

The collision avoidance support unit 55 may generate notice information for urging a driving corresponding to the traveling support of the ego vehicle to the driver of the ego vehicle, as the traveling support of the ego vehicle; and may inform the notice information to the driver. The notice information includes information for urging a deceleration, an acceleration, or a lane change for avoiding the collision to the merging vehicle. The notice information is outputted from the human interface apparatus 37, such as the loudspeaker or the display screen.

Not only the traveling of the ego vehicle, but also the traveling of the merging vehicle may be supported, or the traveling of the peripheral vehicle may also be supported.

### 1-1-6. Traveling Support Selection Unit 56

The traveling support selection unit 56 determines whether the traveling support of the merging support unit 53 or the traveling support of the collision avoidance support unit 55 is performed; and makes determined the merging support unit 53 or the collision avoidance support unit 55 perform the traveling support.

As mentioned above, the merging behavior into the ego lane of the merging vehicle is predicted by the merging behavior prediction unit 52; and at least the traveling of the ego vehicle is supported so that the traveling at the time of merging becomes smooth, based on the prediction result of the merging behavior, by the merging support unit 53. Accordingly, by the merging behavior prediction unit 52 and the merging support unit 53, based on the rough prediction result of the merging behavior, the rough traveling support such that the traveling at the time of merging becomes smooth is performed. On the other hand, the movement of the ego vehicle and the movement of the merging vehicle are predicted by the movement prediction unit 54. And, by the collision avoidance support unit 55, the collision risk between the ego vehicle and the merging vehicle is calculated based on the prediction result of movement of the ego vehicle and movement of the merging vehicle, and at least the traveling of the ego vehicle is supported so that the collision risk decreases. Accordingly, by calculating the collision risk based on the movement of each vehicle by the movement prediction unit 54 and the collision avoidance support unit 55, the traveling support such as avoiding collision more certainly is performed.

By determining whether the traveling support of the merging support unit 53 or the traveling support of the collision avoidance support unit 55 is performed by the traveling support selection unit 56, the rough traveling support such that the traveling at the time of merging becomes smooth, and the traveling support such as avoiding collision certainly can be switched appropriately according to conditions.

1-1-6-1. Determination of Traveling Support Based on Positional Relationship between Merging Vehicle and Merging Point

The traveling support selection unit 56 determines whether the traveling support of the merging support unit 53 or the traveling support of the collision avoidance support unit 55 is performed, based on a positional relationship between the position of the merging vehicle, and the position of the merging point between the ego lane and the merging lane.

As a determination method of the traveling support by the positional relationship between the merging vehicle and the merging point, a plurality of determination methods explained in the following can be considered. Each determination method may be used independently, or a plurality of determination results by a plurality of determination methods may be evaluated comprehensively. In the following, each determination method will be explained.

### <Determination of Traveling Support Based on Distance Between Merging Vehicle and Merging Point>

The traveling support selection unit 56 determines that the traveling support of the collision avoidance support unit 55 is performed, when the distance between the merging vehicle and the merging point becomes less than a threshold value; and determines that the traveling support of the merging support unit 53 is performed, when the distance becomes greater than or equal to the threshold value. The threshold value may be changed based on the speed of the merging vehicle, the type of merging lane, and the like.

According to this configuration, as shown in FIG. 13, when the merging vehicle is distant from the merging point more than the threshold value, the merging support unit 53 can perform the rough traveling support such that the traveling at the time of merging becomes smooth, beforehand with respect to the merging point. On the other hand, when the merging vehicle approaches the merging point, the merging vehicle is obliged to merge if it cannot stop, and a possibility that the merging is actually performed becomes high. Accordingly, when the distance between the merging vehicle and the merging point becomes less than the threshold value, the traveling support such as avoiding collision more certainly by the collision avoidance support unit 55 can be performed.

### <Determining Method of Traveling Support by Arrival Prediction Time to Merging Point>

The traveling support selection unit 56 predicts an arrival prediction time when the merging vehicle arrives at the merging point, based on the positional relationship between the position of the merging vehicle and the position of the merging point; and determines whether the traveling support of the merging support unit 53 or the traveling support of the collision avoidance support unit 55 is performed, based on the arrival prediction time. For example, the arrival prediction time is calculated by dividing a distance from the merging vehicle to the merging point by the speed of the merging vehicle or the regulation speed of the merging lane. The acceleration of the merging vehicle may be considered.

For example, the traveling support selection unit 56 determines that the traveling support of the collision avoidance support unit 55 is performed, when the arrival prediction time of the merging vehicle becomes less than a threshold value; and determines that the traveling support of the merging support unit 53 is performed, when the arrival prediction time becomes greater than or equal to the threshold value.

According to this configuration, when the arrival prediction time is greater than or equal to the threshold value, the merging support unit 53 can perform the rough traveling support such that the traveling at the time of merging becomes smooth, beforehand with respect to the merging point. On the other hand, when the arrival prediction time becomes short, the merging vehicle is obliged to merge if it cannot stop, and a possibility that the merging is actually performed becomes high. Accordingly, when the arrival prediction time becomes less than the threshold value, the traveling support such as avoiding collision more certainly by the collision avoidance support unit 55 can be performed.

### <Determination Method of Traveling Support by Stop Possibility of Merging Vehicle>

The traveling support selection unit 56 determines a stop possibility that the merging vehicle can stop at the merging point, based on a positional relationship between the position of the merging vehicle and the position of the merging point; and determines whether the traveling support of the merging support unit 53 or the traveling support of the collision avoidance support unit 55 is performed, based on the stop possibility.

For example, the traveling support selection unit 56 calculates a distance (stopping distance) until the merging vehicle stops by a specific deceleration behavior, based on the speed of the merging vehicle. The traveling support selection unit 56 determines that the merging vehicle can stop, when the stopping distance is less than the distance from the merging vehicle to the merging point; and determines that the merging vehicle cannot stop when the stopping distance is greater than or equal to the distance. The specific deceleration behavior is set to an emergency brake for collision prevention, and the like.

For example, the traveling support selection unit 56 determines that the traveling support of the collision avoidance support unit 55 is performed, when the merging vehicle cannot stop; and determines that the traveling support of the merging support unit 53 is performed, when the merging vehicle can stop.

According to this configuration, when the merging vehicle cannot stop within the merging lane, even if there is a possibility of collision, a possibility of merging into the ego lane becomes high, without stopping within the merging lane. Accordingly, when the merging vehicle cannot stop, the traveling support for avoiding the collision by the collision avoidance support unit 55 is performed, and the collision can be avoided. On the other hand, when the merging vehicle can stop within the merging lane, since the merging vehicle can also stop within the merging lane when there is a possibility of the collision, it is not necessary to perform the traveling support of the collision avoidance by the collision avoidance support unit 55, and the merging support unit 53 can perform the rough traveling support such that the traveling at the time of merging becomes smooth, beforehand with respect to the merging point.

1-1-6-2. Determination of Traveling Support Based on Positional Relationship between Merging Vehicle and Ego Vehicle

The traveling support selection unit 56 determines whether the traveling support of the merging support unit 53 or the traveling support of the collision avoidance support unit 55 is performed, based on a positional relationship between the position of the merging vehicle and the position of the ego vehicle. Herein, the positional relationship may include not only mere relation between position and position but also information related to the relation between position and position, for example, a time change of positional relationship, that is, a speed relation.

As a determination method of the traveling support by the positional relationship between the merging vehicle and the ego vehicle, a plurality of determination methods explained in the following can be considered. Each determination method may be used independently, or a plurality of determination results by a plurality of determination methods may be evaluated comprehensively. In the following, each determination method will be explained.

### <Determination of Traveling Support Based on Distance Between Merging Vehicle and Ego Vehicle>

The traveling support selection unit 56 determines that the traveling support of the collision avoidance support unit 55 is performed, when the distance between the merging vehicle and the ego vehicle becomes less than a threshold value; and determines that the traveling support of the merging support unit 53 is performed, when the distance between the merging vehicle and the ego vehicle becomes greater than or equal to the threshold value. The threshold value may be changed based on the relative speed, the type of merging lane, and the like.

According to this configuration, when the distance between the merging vehicle and the ego vehicle is distant more than the threshold value, since the possibility of collision between the merging vehicle and the ego vehicle is low, the rough traveling support such that the traveling at the time of merging becomes smooth by the merging support unit 53 can be performed. On the other hand, when the distance between the merging vehicle and the ego vehicle approaches, there is a possibility of collision between the merging vehicle and the ego vehicle if the merging is performed. Accordingly, when the distance between the merging vehicle and the ego vehicle becomes less than the threshold value, the traveling support such as avoiding collision more certainly by the collision avoidance support unit 55 can be performed.

### <Determination Method of Traveling Support by Collision Possibility>

The traveling support selection unit 56 determines a collision possibility between the merging vehicle and the ego vehicle, based on the positional relationship between the position of the merging vehicle and the position of the ego vehicle; and determines whether the traveling support of the merging support unit 53 or the traveling support of the collision avoidance support unit 55 is performed, based on the collision possibility.

For example, the traveling support selection unit 56 calculates a time to collision as the collision possibility, based on the relative distance and the relative speed of the merging vehicle with respect to the ego vehicle. The traveling support selection unit 56 determines that the traveling support of the collision avoidance support unit 55 is performed, when the time to collision becomes less than a threshold value; and determines that the traveling support of the merging support unit 53 is performed, when the time to collision becomes greater than or equal to the threshold value. For example, the time to collision is calculated by dividing the relative distance by the relative speed.

According to this configuration, when the time to collision becomes less than the threshold value, the possibility of the collision becomes high, the traveling support such as avoiding collision by the collision avoidance support unit 55 can be performed. On the other hand, when the time to collision is greater than or equal to the threshold value, since the possibility of colliding is low, the rough traveling support such that the traveling at the time of merging becomes smooth by the merging support unit 53 can be performed.

### <Determination Method of Traveling Support by Mutual Stop Possibility>

The traveling support selection unit 56 determines a deceleration stop possibility that the merging vehicle can decelerate or stop without colliding with the ego vehicle, or a deceleration stop possibility that the ego vehicle can decelerate or stop without colliding with the merging vehicle, based on the positional relationship between the position of the merging vehicle and the position of the ego vehicle; and determines whether the traveling support of the merging support unit 53 or the traveling support of the collision avoidance support unit 55 is performed, based on the deceleration stop possibility.

For example, the traveling support selection unit 56 determines whether or not the merging vehicle can decelerate or stop without colliding with the ego vehicle when the ego vehicle performs the constant speed traveling and the merging vehicle performs the deceleration traveling. The traveling support selection unit 56 determines whether or not the ego vehicle can decelerate or stop without colliding with the merging vehicle when the merging vehicle performs the constant speed traveling and the ego vehicle performs the deceleration traveling. The traveling support selection unit 56 determines that the traveling support of the collision avoidance support unit 55 is performed, when determining that deceleration or stop is impossible in either case; and determines that the traveling support of the merging support unit 53 is performed, when not determining that deceleration or stop is impossible in neither case. According to the front and back relation between the merging vehicle and the ego vehicle, a vehicle which performs the constant speed traveling, and a vehicle which performs the deceleration traveling may be determined. And, according to a lane priority between the merging lane and the ego lane, a vehicle which performs the constant speed traveling, and a vehicle which performs the deceleration traveling may be determined.

According to this configuration, when determining that deceleration or stop is impossible, the possibility of the collision becomes high, and the traveling support such as avoiding collision by the collision avoidance support unit 55 can be performed. On the other hand, when determining that deceleration or stop is possible, since the possibility of colliding is low, the rough traveling support such that the traveling at the time of merging becomes smooth by the merging support unit 53 can be performed.

### 1-1-6-3. Final Determination of Traveling Support

As explained above, the plurality of determination methods can be considered as the determination method of traveling support. Among the plurality of determination methods of traveling support, predetermined one or a plurality of determination methods may be executed. When the plurality of determination methods of traveling support are executed, the traveling support selection unit 56 evaluates comprehensively the determination results by the plurality of determination methods of traveling support; and finally determines whether the traveling support of the merging support unit 53 or the traveling support of the collision avoidance support unit 55 is performed.

For example, if regarding the collision avoidance as important, the traveling support selection unit 56 may finally determine that the traveling support of the collision avoidance support unit 55 is performed, when there are one or more of determination results that the traveling support of the collision avoidance support unit 55 is performed, among the determination results by the plurality of determination methods of traveling support; and the traveling support selection unit 56 may finally determines that the traveling support of the merging support unit 53 is performed, when there is no determination result.

If balancing the collision avoidance and the smooth merging, the traveling support selection unit 56 may finally determine that the traveling support of the collision avoidance support unit 55 is performed, when there are N or more of determination results that the traveling support of the collision avoidance support unit 55 is performed, among the determination results by the plurality of determination methods of traveling support; and may finally determine that the traveling support of the merging support unit 53 is performed, when there are less than N determination results. N is set to an integer of 2 or more, and is adjusted by a balance degree between them.

### 1-1-7. Flowchart

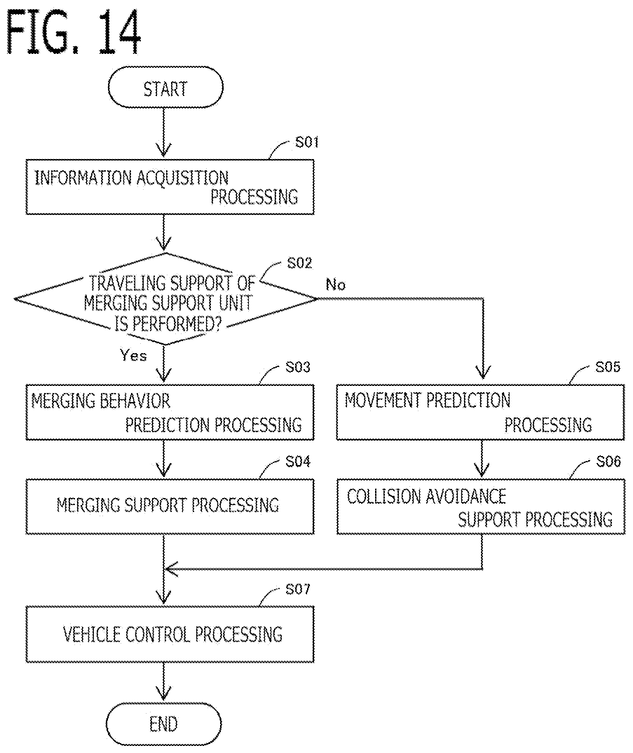

FIG. 14 is a flowchart explaining processing of the traveling support system 1 according to the present embodiment. Processing of FIG. 14 is executed at every predetermined calculation period, for example.

In the step S01, as mentioned above, the information acquisition unit 51 acquires the movement information of the ego vehicle (object vehicle), the movement information of the merging vehicle which is traveling on the merging lane which merges into the ego lane (object lane) where the ego vehicle is traveling, the lane information of the ego lane, and the lane information of the merging lane.

In the step S02, as mentioned above, the traveling support selection unit 56 determines whether the traveling support of the merging support unit 53 or the traveling support of the collision avoidance support unit 55 is performed. Then, when determining that the traveling support of the merging support unit 53 is performed, it advances to the step S03 and makes the merging support unit 53 perform the traveling support. When determining that the traveling support of the collision avoidance support unit 55 is performed, it advances to the step S05 and makes the collision avoidance support unit 55 perform the traveling support. In the present embodiment, the determination methods mentioned above are used for the determination method of traveling support, and explanation is omitted herein.

In the step S03, as mentioned above, the merging behavior prediction unit 52 predicts a merging behavior into the ego lane of the merging vehicle, based on the movement information of the ego vehicle, the movement information of the merging vehicle, the lane information of the ego lane, and the lane information of the merging lane. In the present embodiment, the prediction methods mentioned above are used for the prediction of merging behavior, and explanation is omitted herein.

In the step S04, as mentioned above, the merging support unit 53 supports at least a traveling of the ego vehicle so that a traveling at the time of merging becomes smooth, based on the prediction result of the merging behavior of the merging vehicle.

On the other hand, in the step S05, as mentioned above, the movement prediction unit 54 predicts a movement of the ego vehicle, and a movement of the merging vehicle, based on the movement information of the ego vehicle, the movement information of the merging vehicle, the lane information of the ego lane, and the lane information of the merging lane. In the present embodiment, the prediction methods mentioned above are used for the prediction of movement of each vehicle, and explanation is omitted herein.

In the step S06, as mentioned above, the collision avoidance support unit 55 calculates a collision risk between the ego vehicle and the merging vehicle, based on the prediction result of movement of the ego vehicle, and the prediction result of movement of the merging vehicle; and supports at least the traveling of the ego vehicle so that the collision risk decreases. In the present embodiment, the calculation methods mentioned above is used for the calculation of the collision risk, and explanation is omitted herein.

In the step S07, the vehicle control unit 57 controls the traveling of the ego vehicle according to the command of the traveling support by the merging support unit 53 or the collision avoidance support unit 55. When the traveling support of the merging support unit 53 or the collision avoidance support unit 55 is the notice information for urging a driving corresponding to the traveling support to the driver, the notice information is outputted by the human interface apparatus 37, such as the loudspeaker or the display screen.

### 2. Embodiment 2

Next, the traveling support system 1 according to Embodiment 2 will be explained. The explanation for constituent parts the same as those in Embodiment 1 will be omitted. The basic configuration of the traveling support system 1 according to the present embodiment is the same as that of Embodiment 1. Embodiment 2 is different from Embodiment 1 in that the prediction result of movement of each vehicle by the movement prediction unit 54 is used in the traveling support selection unit 56.

In the present embodiment, the traveling support selection unit 56 determines whether the traveling support of the merging support unit 53 or the traveling support of the collision avoidance support unit 55 is performed, based on the prediction result of movement of the ego vehicle and the prediction result of movement of the merging vehicle by the movement prediction unit 54.

According to this configuration, based on the prediction results of movements of the ego vehicle and the merging vehicle, it can be highly determined whether it is a condition where the collision avoidance by the collision avoidance support unit 55 is required, or a condition where the possibility of collision is low and the traveling at the time of merging is made smooth by the merging support unit 53.

For example, similarly to the collision avoidance support unit 55, the traveling support selection unit 56 calculates a collision risk between the ego vehicle and the merging vehicle, based on the prediction result of movement of the ego vehicle, and the prediction result of movement of the merging vehicle; and determines whether the traveling support of the merging support unit 53 or the traveling support of the collision avoidance support unit 55 is performed, based on the collision risk. Specifically, the traveling support selection unit 56 determines that the traveling support of the collision avoidance support unit 55 is performed, when the collision risk is greater than or equal to a threshold value; and determines that the traveling support of the merging support unit 53 is performed, when the collision risk is less than the threshold value.

Since a method similar to the collision avoidance support unit 55 explained in Embodiment 1 is used for calculation of the collision risk, explanation is omitted. Before execution of the traveling support selection unit 56, calculation processing of the collision risk of the collision avoidance support unit 55 is executed, the calculated collision risk may be used in the traveling support selection unit 56.

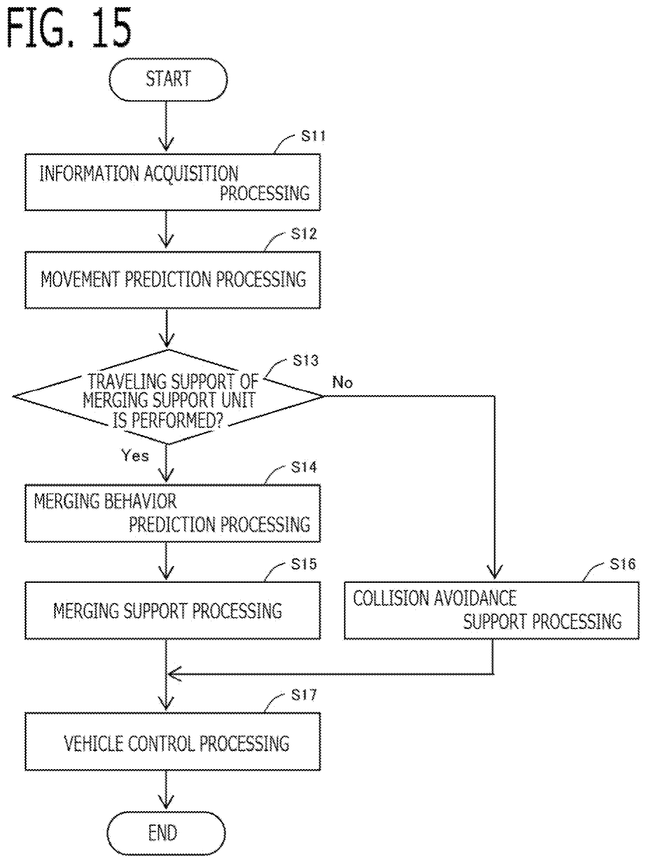

FIG. 15 is a flowchart explaining processing of the traveling support system 1 according to the present embodiment. Processing of FIG. 15 is executed at every predetermined calculation period, for example.

In the step S11, as explained in Embodiment 1, the information acquisition unit 51 acquires the movement information of the ego vehicle (object vehicle), the movement information of the merging vehicle which is traveling on the merging lane which merges into the ego lane (object lane) where the ego vehicle is traveling, the lane information of the ego lane, and the lane information of the merging lane.

In the step S12, as explained in Embodiment 1, the movement prediction unit 54 predicts a movement of the ego vehicle, and a movement of the merging vehicle, based on the movement information of the ego vehicle, the movement information of the merging vehicle, the lane information of the ego lane, and the lane information of the merging lane.

In the step S13, as mentioned above, the traveling support selection unit 56 determines whether the traveling support of the merging support unit 53 or the traveling support of the collision avoidance support unit 55 is performed, based on the prediction result of movement of the ego vehicle and the prediction result of movement of the merging vehicle by the movement prediction unit 54. Then, when determining that the traveling support of the merging support unit 53 is performed, it advances to the step S14 and makes the merging support unit 53 perform the traveling support. When determining that the traveling support of the collision avoidance support unit 55 is performed, it advances to the step S16 and makes the collision avoidance support unit 55 perform the traveling support.

In the step S14, as explained in Embodiment 1, the merging behavior prediction unit 52 predicts a merging behavior into the ego lane of the merging vehicle, based on the movement information of the ego vehicle, the movement information of the merging vehicle, the lane information of the ego lane, and the lane information of the merging lane.

In the step S15, as explained in Embodiment 1, the merging support unit 53 supports at least a traveling of the ego vehicle so that a traveling at the time of merging becomes smooth, based on the prediction result of the merging behavior of the merging vehicle.

On the other hand, in the step S16, as explained in Embodiment 1, the collision avoidance support unit 55 calculates a collision risk between the ego vehicle and the merging vehicle, based on the prediction result of movement of the ego vehicle, and the prediction result of movement of the merging vehicle; and supports at least the traveling of the ego vehicle so that the collision risk decreases.

In the step S17, as explained in Embodiment 1, the vehicle control unit 57 controls the traveling of the ego vehicle according to the command of the traveling support by the merging support unit 53 or the collision avoidance support unit 55. When the traveling support of the merging support unit 53 or the collision avoidance support unit 55 is the notice information for urging a driving corresponding to the traveling support to the driver, the notice information is outputted by the human interface apparatus 37, such as the loudspeaker or the display screen.

### 3. Embodiment 3

Next, the traveling support system 1 according to Embodiment 3 will be explained. The explanation for constituent parts the same as those in Embodiment 1 will be omitted. The basic configuration of the traveling support system. 1 according to the present embodiment is the same as that of Embodiment 1. The number of the merging support unit 53 and the collision avoidance support unit 55 is different from Embodiment 1.

In the present embodiment, the one merging support unit 53 or a plurality of the merging support units 53 which can perform mutually different traveling support, and the one collision avoidance support unit 55 or a plurality of the collision avoidance support units 55 which can perform mutually different traveling support are provided. The total number of the merging support unit 53 and the collision avoidance support unit 55 is set to three or more. Then, the traveling support selection unit 56 determines whether the traveling support of the one or the plurality of merging support units 53, or the one or the plurality of collision avoidance support units 55 is performed.

According to this configuration, type of selectable traveling support is increased, and more flexible traveling support becomes possible.

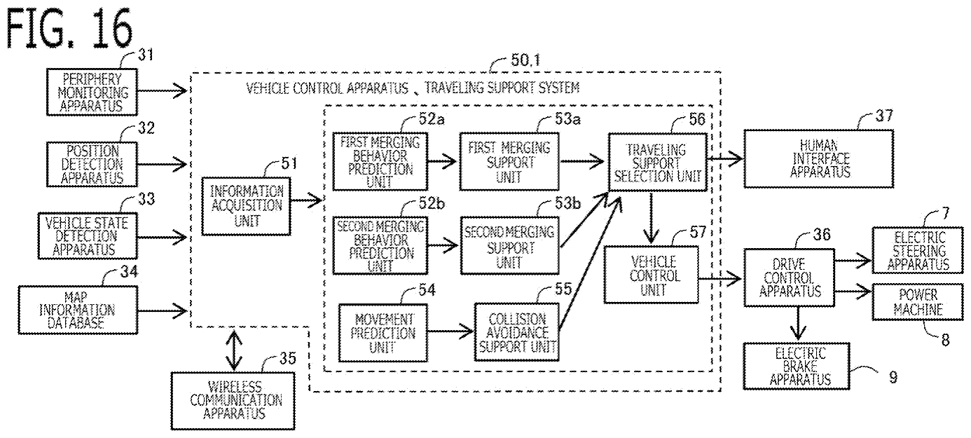

In the present embodiment, as shown in FIG. 16, a case where the first and the second merging support units 53a, 53b, and the one collision avoidance support unit 55 are provided is explained as an example. A first merging behavior prediction unit 52a for the first merging support units 53a, and a second merging behavior prediction unit 52b for the second merging support units 53b are provided.

In the present embodiment, when determining that the merging vehicle can stop before the merging point, and the distance between the merging vehicle and the merging point is greater than or equal to a threshold value, the traveling support selection unit 56 determines that the traveling support of the first merging support unit 53a is performed, and makes the first merging support unit 53a perform the traveling support. When determining that the merging vehicle can stop before the merging point, and the distance between the merging vehicle and the merging point is less than the threshold value, the traveling support selection unit 56 determines that the traveling support of the second merging support unit 53b is performed, and makes the second merging support unit 53b perform the traveling support. On the other hand, when determining that the merging vehicle cannot stop before the merging point, the traveling support selection unit 56 determines that the traveling support of the collision avoidance support unit 55 is performed, and makes the collision avoidance support unit 55 perform the traveling support. The methods described in Embodiment 1 is used for determination in each case.

The first merging behavior prediction unit 52a predicts the merging behavior into the ego lane of the merging vehicle using the prediction model. Since the prediction method using the prediction model is similarly to Embodiment 1, explanation is omitted. The first merging support unit 53a supports at least the traveling of the ego vehicle so that the traveling at the time of merging becomes smooth, based on the prediction result of the merging behavior by the first merging behavior prediction unit 52a. Since the content of prediction traveling support is similarly to Embodiment 1, explanation is omitted.

The second merging behavior prediction unit 52b predicts that the merging vehicle merges on the front side of the ego vehicle, when the merging vehicle is traveling in the front of the ego vehicle; and predicts that the merging vehicle merges on the back side of the ego vehicle, when the merging vehicle is traveling in the back of the ego vehicle. The second merging support unit 53b supports at least the traveling of the ego vehicle so that the traveling at the time of merging becomes smooth, based on the prediction result of the merging behavior by the second merging behavior prediction unit 52b. Since the prediction methods of merging behavior are different between the first merging behavior prediction unit 52a and the second merging behavior prediction unit 52b, the results of traveling support may be mutually different between the first merging support unit 53a and the second merging support unit 53b.

Since the configuration of the movement prediction unit 54 and the collision avoidance support unit 55 is similarly to Embodiment 1, explanation is omitted. A plurality of collision avoidance support units 55 may be provided. Each of the plurality of collision avoidance support units 55 calculates the collision risk using mutually different methods. Since the calculating methods of the collision risk are different, the results of traveling support may be mutually different.

### 4. Embodiment 4

Next, the traveling support system 1 according to Embodiment 4 will be explained. The explanation for constituent parts the same as those in Embodiment 1 will be omitted. The basic configuration of the traveling support system. 1 according to the present embodiment is the same as that of Embodiment 1.

In each of the above-mentioned embodiments, there was explained the case where the traveling support system 1 is provided in the ego vehicle (object vehicle). In the present embodiment, a part or all of the traveling support system 1 is provided in a server connected to the network.

For example, in an automatic driving of a limited area, such as a distribution center and a factory, vehicles within the area may be controlled by a control server. Even in such a case, the traveling support system 1 can be utilized. Alternatively, in vehicles which can travel on an ordinary road, in order to reduce the calculation processing load of the vehicle control apparatus 50, a part or all of the traveling support system 1 is provided in the server connected to the network.

The object vehicle is set to each control object vehicle which exists within an area where the traveling support system 1 controls. And, about each control object vehicle, the traveling support similar to each of above Embodiments can be performed.

The information acquisition unit 51 acquires the movement information of each object vehicle, the movement information of each merging vehicle which is traveling on each merging lane which merges into each object lane where each object vehicle is traveling, the lane information of each object lane, and the lane information of each merging lane, from each control object vehicle and the monitoring apparatus which monitors the area, by communication. Then, the merging behavior prediction unit 52, the merging support unit 53, the movement prediction unit 54, the collision avoidance support unit 55, and the traveling support selection unit 56 perform processing similar to each Embodiment for each object vehicle and the merging vehicle corresponding to each object vehicle, and perform the traveling support for at least each object vehicle. The content of the traveling support of each vehicle is transmitted to each vehicle by communication.

### Summary of Aspects of the Present Disclosure

Hereinafter, the aspects of the present disclosure is summarized as appendixes.

### (Appendix 1)

A traveling support system comprising:
an information acquisition unit that acquires movement information of an object vehicle, movement information of a merging vehicle which is traveling on a merging lane which merges into an object lane where the object vehicle is traveling, lane information of the object lane, and lane information of the merging lane;
a merging behavior prediction unit that predicts a merging behavior into the object lane of the merging vehicle, based on the movement information of the object vehicle, the movement information of the merging vehicle, the lane information of the object lane, and the lane information of the merging lane;
a merging support unit that supports at least a traveling of the object vehicle so that a traveling at a time of merging becomes smooth, based on a prediction result of the merging behavior;
a movement prediction unit that predicts a movement of the object vehicle and a movement of the merging vehicle, based on the movement information of the object vehicle, the movement information of the merging vehicle, the lane information of the object lane, and the lane information of the merging lane;
a collision avoidance support unit that calculates a collision risk between the object vehicle and the merging vehicle, based on a prediction result of the movement of the object vehicle, and a prediction result of the movement of the merging vehicle, and supports at least a traveling of the object vehicle so that the collision risk decreases; and
a traveling support selection unit that determines whether a traveling support of the merging support unit or a traveling support of the collision avoidance support unit is performed, and makes determined the merging support unit or the collision avoidance support unit perform the traveling support.

### (Appendix 2)

The traveling support system according to appendix 1,
wherein the merging behavior prediction unit predicts the merging behavior, without calculating the collision risk which is based on the prediction result of movement of each vehicle.

### (Appendix 3)

The traveling support system according to appendix 1 or 2,
wherein the merging behavior prediction unit predicts the merging behavior, using a prediction model which receives a feature value of at least one or both of a position and a speed of the merging vehicle, and outputs a prediction result of a merging position of the merging vehicle on front side or back side with respect to the object vehicle.

### (Appendix 4)

The traveling support system according to anyone of appendixes 1 to 3,
wherein the merging support unit supports at least the traveling of the object vehicle so that a vehicle distance between the object vehicle and the merging vehicle at the time of merging is secured, based on the prediction result of the merging behavior.

### (Appendix 5)

The traveling support system according to anyone of appendixes 1 to 4,
wherein the collision avoidance support unit calculates a distance between a position of the object vehicle and a position of the merging vehicle at each time point; calculates the collision risk at each time point, based on the distance at each time point; and supports at least the traveling of the object vehicle so that the collision risk at each time point decreases.

### (Appendix 6)

The traveling support system according to anyone of appendixes 1 to 5,
wherein the movement prediction unit predicts a moving position range where the object vehicle may be located, and a moving position range where the merging vehicle may be located, at each time point,
wherein the collision avoidance support unit calculates an overlap degree or a separation degree between the moving position range of the object vehicle and the moving position range of the merging vehicle, at each time point; calculates the collision risk at each time point, based on the overlap degree or the separation degree at each time point; and supports at least the traveling of the object vehicle so that the collision risk at each time point decreases.

### (Appendix 7)

The traveling support system according to anyone of appendixes 1 to 6,
wherein the movement prediction unit selects a movement pattern with high selection probability from a plurality of movement patterns which the merging vehicle may perform; and predicts the movement of the merging vehicle on condition of the selected movement pattern.

### (Appendix 8)

The traveling support system according to anyone of appendixes 1 to 7,
wherein the traveling support selection unit determines whether the traveling support of the merging support unit or the traveling support of the collision avoidance support unit is performed, based on a positional relationship between a position of the merging vehicle, and a position of a merging point between the object lane and the merging lane.

### (Appendix 9)

The traveling support system according to appendix 8,
wherein the traveling support selection unit predicts an arrival prediction time when the merging vehicle arrives at the merging point, based on the positional relationship between the position of the merging vehicle and the position of the merging point; and determines whether the traveling support of the merging support unit or the traveling support of the collision avoidance support unit is performed, based on the arrival prediction time.

### (Appendix 10)

The traveling support system according to appendix 8,
wherein the traveling support selection unit determines a stop possibility which is a possibility that the merging vehicle can stop at the merging point between the object lane and the merging lane, based on the positional relationship between the position of the merging vehicle and the position of the merging point; and determines whether the traveling support of the merging support unit or the traveling support of the collision avoidance support unit is performed, based on the stop possibility.

### (Appendix 11)

The traveling support system according to anyone of appendixes 1 to 9,
wherein the traveling support selection unit determines whether the traveling support of the merging support unit or the traveling support of the collision avoidance support unit is performed, based on the positional relationship between the position of the merging vehicle and the position of the object vehicle.

### (Appendix 12)

The traveling support system according to appendix 11,
wherein the traveling support selection unit determines a collision possibility between the merging vehicle and the object vehicle, based on the positional relationship between the position of the merging vehicle and the position of the object vehicle; and determines whether the traveling support of the merging support unit or the traveling support of the collision avoidance support unit is performed, based on the collision possibility.

### (Appendix 13)

The traveling support system according to any one of appendixes 1 to 7,
wherein the traveling support selection unit determines a deceleration stop possibility which is a possibility that the merging vehicle can decelerate or stop without colliding with the object vehicle, or a deceleration stop possibility which is a possibility that the object vehicle can decelerate or stop without colliding with the merging vehicle, based on a positional relationship between a position of the merging vehicle and a position of the object vehicle; and determines whether the traveling support of the merging support unit or the traveling support of the collision avoidance support unit is performed, based on the deceleration stop possibility.

### (Appendix 14)

The traveling support system according to any one of appendixes 1 to 7,
wherein the traveling support selection unit determines whether the traveling support of the merging support unit or the traveling support of the collision avoidance support unit is performed, based on the prediction result of the movement of the object vehicle and the prediction result of the movement of the merging vehicle by the movement prediction unit.

### (Appendix 15)

The traveling support system according to anyone of appendixes 1 to 14,
wherein the one merging support unit or a plurality of the merging support units which can perform mutually different traveling support, and the one collision avoidance support unit or a plurality of the collision avoidance support units which can perform mutually different traveling support are provided, and
wherein the traveling support selection unit determines whether the traveling support of the one or the plurality of merging support units, or the traveling support of the one or the plurality of collision avoidance support units is performed.

### (Appendix 16)

The traveling support system according to anyone of appendixes 1 to 15,
wherein the merging support unit and the collision avoidance support unit calculate a control value of vehicle operation, as the traveling support.

### (Appendix 17)

The traveling support system according to anyone of appendixes 1 to 15,
wherein the merging support unit and the collision avoidance support unit generate notice information for urging a driving corresponding to the traveling support to a driver, as the traveling support; and informs the notice information to the driver.

### (Appendix 18)

The traveling support system according to any one of appendixes 1 to 17,
wherein the information acquisition unit can acquire the movement information of the merging vehicle and the lane information of the merging lane, from outside of the object vehicle by communication.

### (Appendix 19)

The traveling support system according to any one of appendixes 1 to 18,
wherein a part or all of the traveling support system is provided in a server.

### (Appendix 20)

The traveling support system according to any one of appendixes 1 to 18,
wherein the traveling support system is provided in the object vehicle.

### (Appendix 21)

A traveling support method comprising:
an information acquisition step of acquiring movement information of an object vehicle, movement information of a merging vehicle which is traveling on a merging lane which merges into an object lane where the object vehicle is traveling, lane information of the object lane, and lane information of the merging lane;
a merging behavior prediction step of predicting a merging behavior into the object lane of the merging vehicle, based on the movement information of the object vehicle, the movement information of the merging vehicle, the lane information of the object lane, and the lane information of the merging lane;
a merging support step of supporting at least a traveling of the object vehicle so that a traveling at the time of merging becomes smooth, based on a prediction result of the merging behavior;
a movement prediction step of predicting a movement of the object vehicle and a movement of the merging vehicle, based on the movement information of the object vehicle, the movement information of the merging vehicle, the lane information of the object lane, and the lane information of the merging lane;
a collision avoidance support step of calculating a collision risk between the object vehicle and the merging vehicle, based on a prediction result of the movement of the object vehicle, and a prediction result of the movement of the merging vehicle, and supports at least a traveling of the object vehicle so that the collision risk decreases; and
a traveling support selection step of determining whether a traveling support of the merging support step or a traveling support of the collision avoidance support step is performed, and makes determined the merging support step or the collision avoidance support step perform the traveling support.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. A traveling support system comprising at least one processor configured to implement:
an information acquisitor that acquires movement information of an object vehicle, movement information of a merging vehicle which is traveling on a merging lane which merges into an object lane where the object vehicle is traveling, lane information of the object lane, and lane information of the merging lane;
a merging behavior predictor that predicts a merging behavior into the object lane of the merging vehicle, based on the movement information of the object vehicle, the movement information of the merging vehicle, the lane information of the object lane, and the lane information of the merging lane;
a merging supporter that supports at least a traveling of the object vehicle so that a traveling at a time of merging becomes smooth, based on a prediction result of the merging behavior;
a movement predictor that predicts a movement of the object vehicle and a movement of the merging vehicle, based on the movement information of the object vehicle, the movement information of the merging vehicle, the lane information of the object lane, and the lane information of the merging lane;
a collision avoidance supporter that calculates a collision risk between the object vehicle and the merging vehicle, based on a prediction result of the movement of the object vehicle, and a prediction result of the movement of the merging vehicle, and supports at least a traveling of the object vehicle so that the collision risk decreases; and
a traveling support selector that determines whether a traveling support of the merging supporter or a traveling support of the collision avoidance supporter is performed, and makes determined the merging supporter or the collision avoidance supporter perform the traveling support.

2. The traveling support system according to claim 1,
wherein the merging behavior predictor predicts the merging behavior, without calculating the collision risk which is based on the prediction result of movement of each vehicle.

3. The traveling support system according to claim 1,
wherein the merging behavior predictor predicts the merging behavior, using a prediction model which receives a feature value of at least one or both of a position and a speed of the merging vehicle, and outputs a prediction result of a merging position of the merging vehicle on front side or back side with respect to the object vehicle.

4. The traveling support system according to claim 1,
wherein the merging supporter supports at least the traveling of the object vehicle so that a vehicle distance between the object vehicle and the merging vehicle at the time of merging is secured, based on the prediction result of the merging behavior.

5. The traveling support system according to claim 1,
wherein the collision avoidance supporter calculates a distance between a position of the object vehicle and a position of the merging vehicle at each time point; calculates the collision risk at each time point, based on the distance at each time point; and supports at least the traveling of the object vehicle so that the collision risk at each time point decreases.

6. The traveling support system according to claim 1,
wherein the movement predictor predicts a moving position range where the object vehicle may be located, and a moving position range where the merging vehicle may be located, at each time point,
wherein the collision avoidance supporter calculates an overlap degree or a separation degree between the moving position range of the object vehicle and the moving position range of the merging vehicle, at each time point; calculates the collision risk at each time point, based on the overlap degree or the separation degree at each time point; and supports at least the traveling of the object vehicle so that the collision risk at each time point decreases.

7. The traveling support system according to claim 1,
wherein the movement predictor selects a movement pattern with high selection probability from a plurality of movement patterns which the merging vehicle may perform; and predicts the movement of the merging vehicle on condition of the selected movement pattern.

8. The traveling support system according to claim 1,
wherein the traveling support selector determines whether the traveling support of the merging supporter or the traveling support of the collision avoidance supporter is performed, based on a positional relationship between a position of the merging vehicle, and a position of a merging point between the object lane and the merging lane.

9. The traveling support system according to claim 8,
wherein the traveling support selector predicts an arrival prediction time when the merging vehicle arrives at the merging point, based on the positional relationship between the position of the merging vehicle and the position of the merging point; and determines whether the traveling support of the merging supporter or the traveling support of the collision avoidance supporter is performed, based on the arrival prediction time.

10. The traveling support system according to claim 8,
wherein the traveling support selector determines a stop possibility which is a possibility that the merging vehicle can stop at the merging point between the object lane and the merging lane, based on the positional relationship between the position of the merging vehicle and the position of the merging point; and determines whether the traveling support of the merging supporter or the traveling support of the collision avoidance supporter is performed, based on the stop possibility.

11. The traveling support system according to claim 1,
wherein the traveling support selector determines whether the traveling support of the merging supporter or the traveling support of the collision avoidance supporter is performed, based on the positional relationship between the position of the merging vehicle and the position of the object vehicle.

12. The traveling support system according to claim 11,
wherein the traveling support selector determines a collision possibility between the merging vehicle and the object vehicle, based on the positional relationship between the position of the merging vehicle and the position of the object vehicle; and determines whether the traveling support of the merging supporter or the traveling support of the collision avoidance supporter is performed, based on the collision possibility.

13. The traveling support system according to claim 1,
wherein the traveling support selector determines a deceleration stop possibility which is a possibility that the merging vehicle can decelerate or stop without colliding with the object vehicle, or a deceleration stop possibility which is a possibility that the object vehicle can decelerate or stop without colliding with the merging vehicle, based on a positional relationship between a position of the merging vehicle and a position of the object vehicle; and determines whether the traveling support of the merging supporter or the traveling support of the collision avoidance supporter is performed, based on the deceleration stop possibility.

14. The traveling support system according to claim 1,
wherein the traveling support selector determines whether the traveling support of the merging supporter or the traveling support of the collision avoidance supporter is performed, based on the prediction result of the movement of the object vehicle and the prediction result of the movement of the merging vehicle by the movement predictor.

15. The traveling support system according to claim 1,
wherein the one merging supporter or a plurality of the merging supporters which can perform mutually different traveling support, and the one collision avoidance supporter or a plurality of the collision avoidance supporters which can perform mutually different traveling support are provided, and
wherein the traveling support selector determines whether the traveling support of the one or the plurality of merging supporters, or the traveling support of the one or the plurality of collision avoidance supporters is performed.

16. The traveling support system according to claim 1,
wherein the merging supporter and the collision avoidance supporter calculate a control value of vehicle operation, as the traveling support.

17. The traveling support system according to claim 1,
wherein the merging supporter and the collision avoidance supporter generate notice information for urging a driving corresponding to the traveling support to a driver, as the traveling support; and informs the notice information to the driver.

18. The traveling support system according to claim 1,
wherein the information acquisitor can acquire the movement information of the merging vehicle and the lane information of the merging lane, from outside of the object vehicle by communication.

19. The traveling support system according to claim 1,
wherein a part or all of the traveling support system is provided in a server.

20. The traveling support system according to claim 1,
wherein the traveling support system is provided in the object vehicle.

21. A traveling support method comprising:
an information acquisition step of acquiring movement information of an object vehicle, movement information of a merging vehicle which is traveling on a merging lane which merges into an object lane where the object vehicle is traveling, lane information of the object lane, and lane information of the merging lane;
a merging behavior prediction step of predicting a merging behavior into the object lane of the merging vehicle, based on the movement information of the object vehicle, the movement information of the merging vehicle, the lane information of the object lane, and the lane information of the merging lane;
a merging support step of supporting at least a traveling of the object vehicle so that a traveling at the time of merging becomes smooth, based on a prediction result of the merging behavior;
a movement prediction step of predicting a movement of the object vehicle and a movement of the merging vehicle, based on the movement information of the object vehicle, the movement information of the merging vehicle, the lane information of the object lane, and the lane information of the merging lane;
a collision avoidance support step of calculating a collision risk between the object vehicle and the merging vehicle, based on a prediction result of the movement of the object vehicle, and a prediction result of the movement of the merging vehicle, and supports at least a traveling of the object vehicle so that the collision risk decreases; and
a traveling support selection step of determining whether a traveling support of the merging support step or a traveling support of the collision avoidance support step is performed, and makes determined the merging support step or the collision avoidance support step perform the traveling support.
